(19) United States
(12) Patent Application Publication
(10) Pub. No.: US 2024/0268578 A1
(43) Pub. Date: Aug. 15, 2024

(54) PLUG-IN OBJECT AND SHELF SYSTEM

(71) Applicant: SHOP SYSTEMS GMBH, Markdorf (DE)

(72) Inventor: Eugen REMENSPERGER, Sigmaringendorf (DE)

(73) Assignee: SHOP SYSTEMS GMBH, Markdorf (DE)

(21) Appl. No.: 18/433,866

(22) Filed: Feb. 6, 2024

(30) Foreign Application Priority Data
Feb. 13, 2023 (DE) 10 2023 103 400.6

(51) Int. Cl. A47F 5/00; G09F 3/20; H01R 25/14

(52) U.S. Cl. CPC A47F 5/0068; G09F 3/204; G09F 3/208; H01R 25/145

(57) ABSTRACT

Proposed is a plug-in object of a shelf system for goods presentation having a plug-in part for a plug-in apparatus of the shelf system into which the plug-in part is able to be plugged in a matching receptacle, the plug-in part forming electrical contact with a contact device in the plug-in apparatus and supplying electrical energy to an assembly unit having electrical contact points, in order to be able to supply electrical energy to an electrical load. According to the invention, in addition to the assembly unit, provision is made, on the plug-in object, for an electrical mounting device (13) having electrical contact points, which electrical mounting device is supplied with electrical energy via the electrical contact and wherein an electrical information display is inserted in the mounting device, the information display being contacted so as to be supplied with electrical energy.

### FIELD OF THE INVENTION

The present invention relates to a plug-in object and shelf system.

### BACKGROUND OF THE INVENTION

Plug-in objects, which are able to be mounted on a plug-in apparatus of a shelf system, are used in various applications and configurations. The shelf system is used, for example, for the presentation of objects, such as e.g. goods in salesrooms or exhibition rooms, for example, in shops in the retail sector or in the wholesale sector.

### SUMMARY OF THE INVENTION

The object of the present invention is to improve a plug-in object or a shelf system with regard to advantageous assembly and broadening of functionality.

The present invention is based on a plug-in object of a shelf system for goods presentation having a plug-in part for a plug-in apparatus of the shelf system into which the plug-in part is able to be plugged in a matching receptacle, the plug-in part being configured in such a way that, in the state in which the plug-in object is plugged into the plug-in apparatus, the plug-in part forms electrical contact with a contact device in the plug-in apparatus, such as, for example, a profile, and supplies electrical energy to an assembly unit having electrical contact points, in order to be able to supply electrical energy to an electrical load mounted on the assembly unit, e.g. inserted into the latter, for example, a light source.

The electrical contact is made, for example, by electrical contacting between contact points of the plug-in apparatus, on the one hand, and contact points of the plug-in part, on the other hand. For example, current is conducted from the plug-in part to the assembly unit, for example, to the electrical load, in a wired manner, for example, by means of an electrical line, such as, for example, a single-core or multi-core insulated electrical cable.

The essence of the present invention is that, in addition to the assembly unit, provision is made, on the plug-in object, for an electrical mounting device having electrical contact points, which electrical mounting device is supplied with electrical energy via the electrical contact and that an electrical information display is inserted in the mounting device, the information display being contacted so as to be supplied with electrical energy.

Preferably, the precisely one load or the plurality of loads for the assembly unit are different to the electrical information display inserted into the mounting device. For example, the load or the loads is/are electrical loads having a different function and/or different supply voltage level compared to the function and/or supply voltage level of the information display. Advantageously, the contact points on the assembly unit for a load are configured differently to the contact points for the information display.

For example, the plug-in object comprises the plug-in part, for example, precisely two plug-in parts, the assembly unit, the electrical mounting device, the electrical loads and the electrical information display. For example, the plug-in object comprises electrical lines and electrical contact points.

For example, the information display is a display for displaying any desired information. For example, the information display is used for displaying precisely one item of information content or several items of information content which differ from one another. For example, the information display is a component for visualization. For example, the information display comprises a display surface, such as e.g. a screen which reproduces the image. For example, the information display comprises a liquid-crystal display (LCD) or an LC screen.

The liquid-crystal display is made up of liquid crystals. LC screens are economically advantageous, for example, and are characterized by a natural color representation and a higher color accuracy.

For example, the information display is a so-called electronic shelf label or ESL for short. The electronic shelf label is, for example, equipped with e-paper technology. For example, the information display is used e.g. in the fashion or food sector, for example, for labeling the product with regard to the price of the product and/or with regard to other information about the product.

For example, the information display is an electrical price tag and/or an electronic advertisement. For example, the information display has an end piece which, in the state in which the information display is mounted on the mounting device, bridges the electrical current. For example, in the state in which the information display is mounted on the mounting device between an electrical contact point on the information display, for example, on the end piece, and an electrical contact point on the mounting device, electrical contact is formed between the contact points.

For example, the proposed plug-in object allows dynamic pricing in relation to a product presented on the shelf system. For example, a price of the product shown by the information display can be adjusted in real time.

Advantageously, using the proposed plug-in object means that manual replacement of a price tag is no longer necessary, as is necessary, for example, for previous labeling systems.

Advantageously, the proposed plug-in object allows high flexibility in the pricing of the product.

Advantageously, the proposed plug-in object allows an additional item of information content about the product to be displayed via the information display, which additional item of information content is able to be read or used by the customer. For example, the additional item of information content is able to be stored and/or displayed on the display in the form of a QR (quick response) code. For example, the QR code is able to be shown on the information display and is able to be read and used for the customer or another person. For example, the QR code is able to be scanned or read electronically, for example, using a corresponding device, such as e.g. a smartphone having a barcode reader or a data capturing device which optically recognizes barcodes.

For example, the electrical mounting device is present structurally delimited from the assembly unit by a partition. For example, a partition is present between the electrical mounting device and the assembly unit. For example, the partition is a separate component to the mounting device and the assembly unit.

For example, the partition comprises a thin-walled metal component. For example, the partition comprises a continuous thin metal strip.

For example, a partition which is part of the mounting device and/or a partition which is part of the assembly unit are/is alternatively formed.

For example, the mounting device comprises an elongate profile, such as, for example, a rail profile, for example, made of a metal material. For example, the elongate profile comprises the partition.

For example, the mounting device is configured in the form of a current profile having electrical contact points or a socket arrangement having electrical contact points. The electrical contact points are used for electrically contacting electrical contact points, such as for connecting electrical contact points in an electrically conducting manner. For example, electrical energy or electrical current is conducted in a wired manner from the contact device to the mounting device, such as e.g. to the current profile.

For example, the mounting device is arranged on a front side of the plug-in object, which front side, in the state in which the plug-in object is mounted on a shelf system, is located at a front of the shelf system for a user. A user who is in the vicinity of the shelf system is thus able to advantageously and easily read or see or visually recognize an item of information displayed by the information display.

Furthermore, by way of example, the mounting device runs horizontally on the plug-in object in the assembly position. For example, the mounting device is an elongate and/or thin component. For example, a longitudinal direction or a longitudinal axis of the mounting device extends in the horizontal direction. For example, the position of the information display mounted on the mounting device can thus be advantageously set up at an e.g. predefinable horizontal height which is advantageous for displaying an item of information. For example, precisely one information display can be mounted on the mounting device in the horizontal extent of the mounting device at an e.g. arbitrarily selectable position along the mounting device. The mounting device is e.g. formed correspondingly over its entire or part of its longitudinal extent in order to make electrical contact with an information display and supply electrical energy to an information display. For example, the mounting device has a continuous elongate electrical contact strip over the length of the mounting device.

For example, a plurality of information displays can be mounted on the mounting device over the length of the mounting device in the direction of the horizontal extent of the mounting device. For example, the length of an information display is less than the horizontal length of the mounting device.

According to another exemplary configuration, an electrical information display is able to be latched into the mounting device at any point along the mounting device and is thus able to be electrically contacted. For example, an electrical information display is able to be latched into, or otherwise mechanically fastened to, the mounting device at any point along a longitudinal extent of the mounting device. For example, simultaneously with the latched-in or mechanically fastened state being reached, the mounting device is simultaneously electrically contacted or able to be electrically contacted.

For example, the longitudinal extent of the mounting device coincides with the horizontal course of the mounting device on the plug-in object. For example, an electrical contact point is in the form of a section of a continuous electrically conducting section of the mounting device or in the form of one point from any desired points of the overall electrically conducting current-carrying mounting device.

For example, a plurality of information displays are arranged or able to be arranged on the mounting device. For example, two, three, four or five or more than five information displays can be arranged on the mounting device, for example, can be simultaneously present next to one another, depending on the length of the mounting device and/or depending on the length of an information display. For example, a plurality of identical information displays and/or a plurality of different information displays are able to be mounted on the mounting device. For example, a plurality of information displays are present, for example, horizontally next to one another, with or without a spacing between two adjacent information displays, e.g. without a spacing in a horizontal direction or without a spacing in the longitudinal direction of the mounting device.

For example, at least two electrical contact points for forming an electrical circuit when the information display is inserted are present on the mounting device. For example, at least two electrical contact points for forming an electrical circuit for supplying current to the inserted information display are present on the information display.

For example, precisely two electrical contact points for forming an electrical circuit for precisely one inserted information display are present on the mounting device. For example, the precisely two electrical contact points form a double contact point for making the electrical contact with the precisely one information display.

For example, a plurality of double contact points, or contact points respectively formed in pairs, are present on the mounting device for the mounting of a plurality of information displays and/or for the mounting of one information display at various positions on the mounting device. For example, a double contact point is used for making contact with precisely one information display. For example, precisely two contact points per insertable information display are sufficient for forming an electrical circuit or for supplying current to the information display.

According to one exemplary form of the plug-in object, the information display is able to be latched in the mounting device. For example, the information display is latched in the mounting device, for example, latched in manually and detachably.

For example, the information display comprises an electronic labeling display. For example, the information display comprises an electronic price tag. The price tag is used, for example, for displaying a numerical value for an amount of a price and for displaying a unit, such as a unit for a currency associated with the numerical value, for example, for the Euro currency. For example, the information display comprises an electronic labeling display based on so-called “e-paper” technology. For example, an e-paper is a digital form of a printed tag, for example, of a price tag.

For example, the plug-in object comprises a voltage converter between electrical contact at the plug-in part and current profile. For example, the reduced voltage level is consistently applied to the current profile.

This makes it possible to adjust the voltage level to match the electrical loads that are to be latched in in the busbar. For example, an electrical voltage which is applied to the plug-in object from outside or via the plug-in apparatus is reduced. For example, an electrical voltage which is able to be tapped at the plug-in apparatus, e.g. in a profile, and which provides electrical energy for an electrical load of the plug-in object via the electrical contact with the plug-in apparatus, is reduced. For example, the voltage converter is able to reduce an electrical voltage of e.g. 24 volts or 12 volts (V) to 3 volts, or is able to reduce said voltage to another voltage level.

One exemplary arrangement arises when the mounting device is inserted into an assembly profile.

One exemplary arrangement arises when the mounting device is inserted into the assembly unit, for example, when the assembly unit comprises the assembly profile.

For example, the assembly unit comprises the assembly profile; for example, the assembly unit forms the assembly profile.

For example, the mounting device is in the form of a current profile. For example, the mounting device is in the form of a current-carrying profile, such as e.g. a current profile. For example, the mounting device or the current profile is e.g. in the form of a single-piece, metal, elongate current profile. For example, the current profile is a component which carries current uniformly. For example, the current profile is slid into the assembly profile. For example, the mounting device and the assembly profile have matching insertion sections, for example, on the one hand having a linearly extending bar section and on the other hand having a linearly extending recess or depression for suitable connection of the mounting device in the assembly unit or in the assembly profile. For example, the assembly profile has a section which has an approximately U-shaped cross section. For example, the assembly profile has a depressed section which extends in the longitudinal direction of the assembly profile and has an undercut. For example, the undercut is used to hold the slid-in current profile such that the latter cannot move in a direction transverse to the longitudinal extent of the current profile.

For example, for sliding the current profile into the assembly profile, for example, for sliding in at the end, the assembly profile preferably has corresponding linearly extending recesses, in particular, grooves. For example, the mounting device has an elevation, such as e.g. a linearly extending bar, which extends linearly along the mounting device and matches the linearly extending recess. In the state in which the mounting device is inserted into the assembly profile, the recess and the elevation form a form-fitting and/or force-fitting connection, such as e.g. a latching connection.

For example, the assembly profile has linear lamps.

For example, the assembly unit has linear lamps.

For example, the mounting device, in the state in which it is mounted on the shelf system, is arranged on the assembly profile on a front side. For example, the lamps are preferably present on an opposite side which faces away from the front side. The arrangement of the lamps on the opposite side makes it possible for the lamps to effectively illuminate goods on a shelf extending horizontally e.g. between the assembly unit and a profile of the shelf system. The orientation of the mounting device in the state in which it is mounted on a front side of the assembly profile, wherein the information display is inserted in the mounting device, makes it possible for a person in front of the shelf system to effectively recognize an item of information on the information display. At the same time, the goods presented by the shelf system are illuminated such that they can be clearly seen by the person.

For example, the assembly profile comprises electrical contact points for making contact with the current profile. For example, the assembly unit comprises the assembly profile.

For example, the assembly profile comprises electrical contact points for making electrical contact with the, for example, inserted mounting device which is present on the assembly profile and is, for example, in the form of a current profile.

Preferably, the assembly profile is the same length as a current profile of the mounting device. For example, the assembly profile and the current profile are flush or at least approximately flush with one another on both sides at opposite longitudinal ends. For example, in this way both the mounting device or the current profile and the assembly profile can be easily and uniformly covered on the sides. For example, it is possible to use e.g. a plate-like covering panel for this purpose. For example, the covering panels are, for example, able to be mounted such that they are able to be releasably snap-fastened on the opposite common longitudinal ends of assembly profile and current profile.

Viewed from a front side of the plug-in object, in the state in which the latter is mounted on a profile of the shelf system, the current profile is advantageously arranged in front of the assembly profile, or the assembly profile is arranged lying behind the current profile. For example, the mounted current profile covers the assembly unit on the front side, for example, completely or predominantly.

For example, the plug-in object has an electrical load. For example, the electrical load is present arranged on the plug-in object. For example, the electrical load comprises an electrical light source and/or an electrically operated lamp, for example, of an electrical illumination device.

For example, a shelf system composed of a plug-in object according to one of the configurations described above and a plug-in apparatus for the plug-in object is proposed. For example, the plug-in apparatus is part of the shelf system; for example, the plug-in apparatus is part of a profile of the shelf system.

For example, the plug-in apparatus comprises two elongate vertical wall profiles or two socket-like individual profiles or an e.g. elongate horizontal wall profile.

For example, the shelf system is formed together with the plug-in object in such a way that a shelf is able to be mounted on the plug-in object in a horizontal orientation. For example, the shelf system is formed together with the plug-in object in such a way that the shelf, in the state in which it is mounted on the plug-in object, is fixed in place and able to withstand mechanical load, for example for the presentation of goods present on the shelf.

For example, it is possible to use electrically supplied lamps of the shelf system to illuminate the goods and to use the information display to link these goods with an item of information, such as, for example, providing them with an item of price information or with an electronic price tag.

### BRIEF DESCRIPTION OF THE DRAWINGS

The invention will be explained in more detail below on the basis of the description of the figures relating to different exemplary embodiments. Specifically:

FIG. 1 shows a perspective view of a plug-in object and a shelf obliquely from above in an exploded view;

FIG. 2 shows an enlarged view of a section I from FIG. 1;

FIG. 3 shows the arrangement according to FIG. 1 in the assembled state from the front;

FIG. 4 shows the arrangement according to FIG. 3 from above;

FIG. 5 shows the arrangement according to FIG. 3 from the side;

FIG. 6 shows an enlarged view of a section II from FIG. 5;

FIG. 7 shows a cut-off sectional view along the line A-A from FIG. 3;

FIG. 8 shows a view corresponding to FIG. 5 of an alternative arrangement;

FIG. 9 shows an enlarged view of a section III from FIG. 8;

FIG. 10 shows the arrangement from FIGS. 8 and 9 in a view according to FIG. 7;

FIG. 11 shows a perspective view of the arrangement according to FIG. 1 in the assembled state with indicated profiles;

FIG. 12 shows the alternative arrangement according to FIGS. 8 and 9 in the view according to FIG. 11;

FIG. 13 shows an enlarged section from FIG. 11 with the omission of a covering plate on the side;

FIG. 14 shows an enlarged perspective section of part of the plug-in object according to FIG. 13 in a rear view with a covering plate; and

FIG. 15 shows the covering plate from FIG. 14 in a perspective individual view and end sections of electrical lines.

### DETAILED DESCRIPTION OF THE INVENTION

The same reference signs are used in some instances below for corresponding elements of different arrangements.

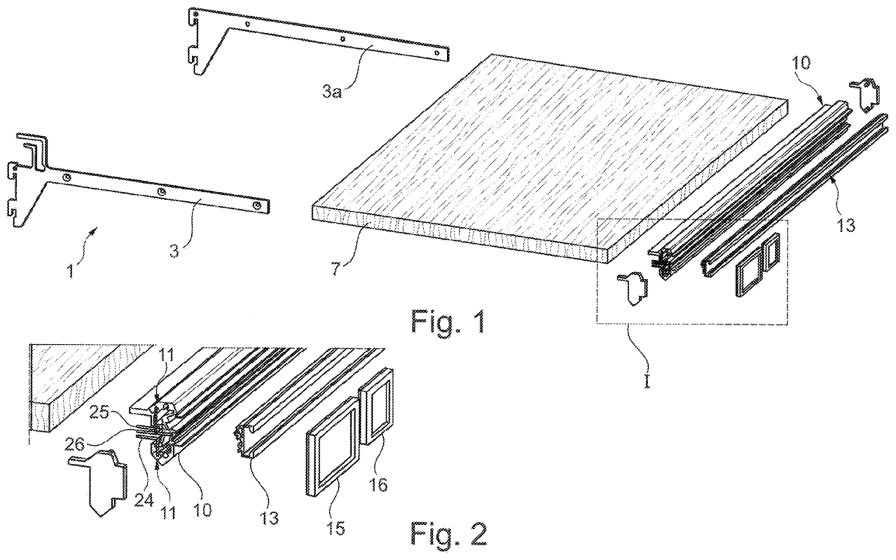

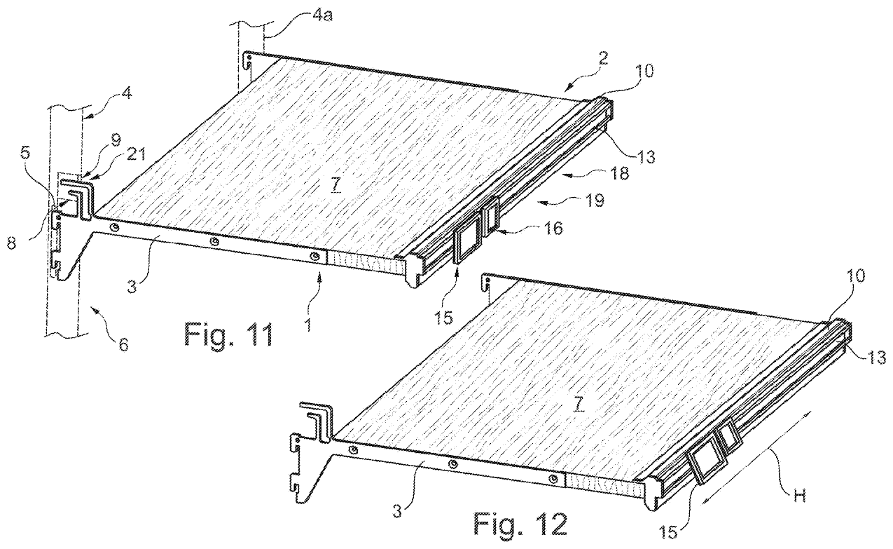

FIG. 1 shows a shelf 7 and a plug-in object 1 of a shelf system 2 for goods presentation. The plug-in object 1 comprises, inter alia, two plug-in parts 3 and 3a. The shelf system 2 has a plug-in apparatus 6 (see FIG. 11), for example, comprising a profile 4 and a profile 4a, for example, wall profiles. In principle, instead of the two elongate vertical profiles 4, 4a, two socket-like individual profiles can be present or an e.g. elongate horizontal profile can be present.

On the profiles 4, 4a, an associated plug-in part 3, 3a is respectively able to be plugged in a matching receptacle 5. For example, the profile 4 schematically illustrated in FIG. 11 and having the receptacle 5 is e.g. oriented vertically. For example, the plug-in parts 3, 3a differ from one another in the area close to the profile and are otherwise identical.

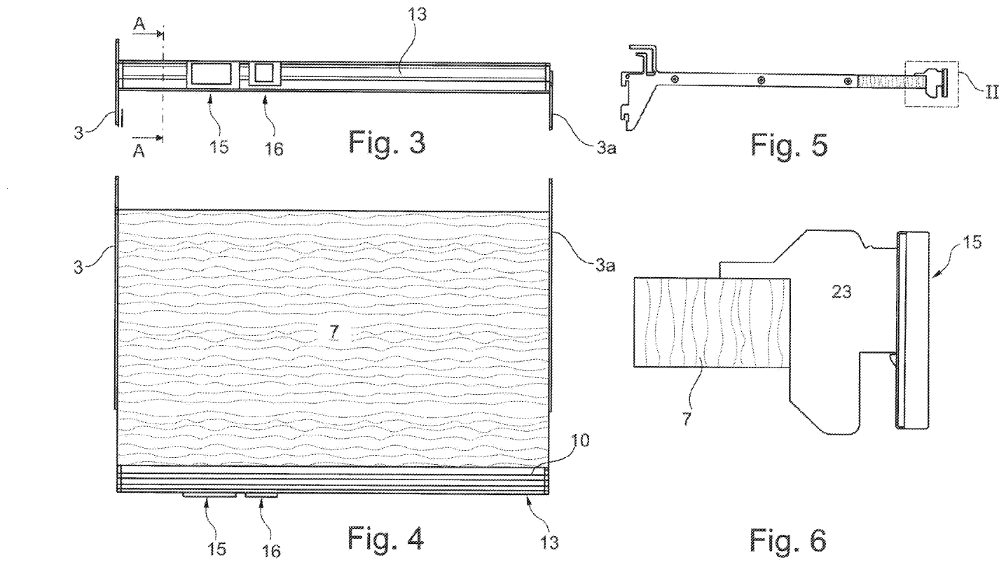

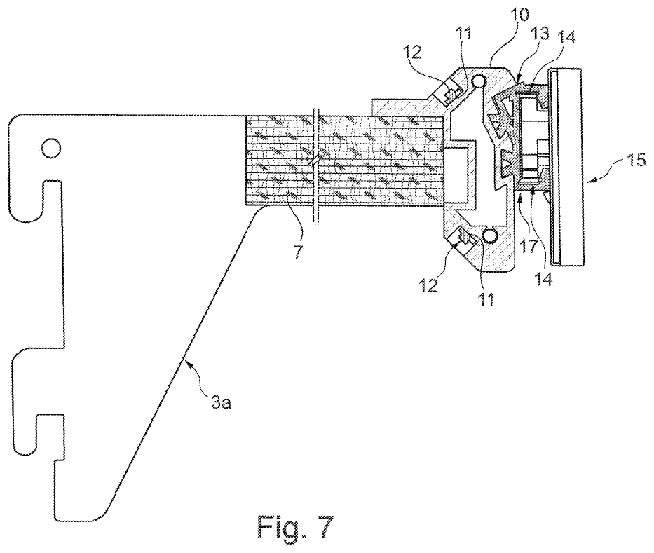

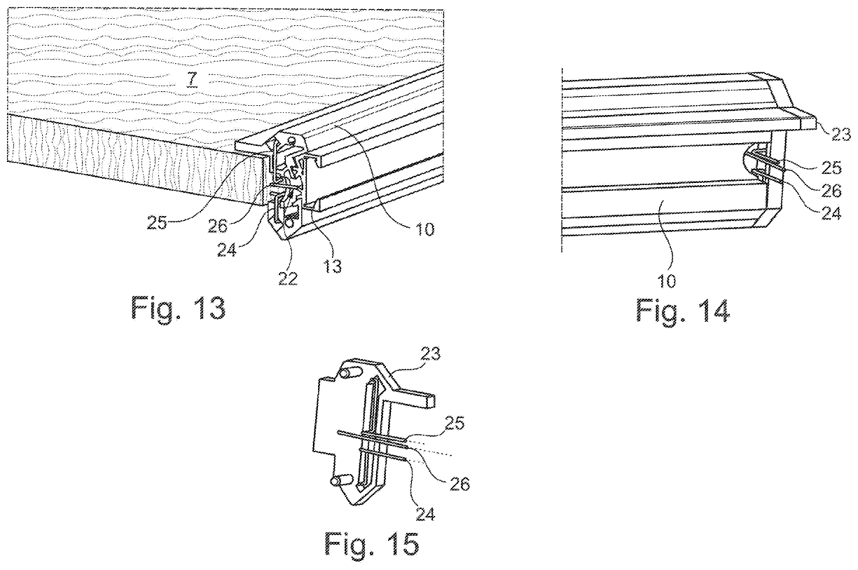

The plug-in part 3, by means of its profile-side contact points (not illustrated), in the state in which the plug-in object 1 is plugged into the plug-in apparatus 6, forms electrical contact with contact points 8 of a contact device 9 in the plug-in apparatus 6 or in the profile 4. Electrical lines 24, 25, 26 are electrically conductively connected to the contact points on the plug-in part 3 (see FIGS. 13-15). The electrical lines 24, 25 run from the contact device 9 to an assembly unit 10 of the plug-in object 1, and the electrical line 26 runs to a mounting device 13. For example, the lines 24-26 are present in a lateral recess in the shelf 7, e.g. covered. The electrical lines 24, 25, 26 are only indicated by an end section in FIGS. 1, 2 and 1 to 15.

The plug-in object 1 has the assembly unit 10 having electrical contact points 11 which are supplied with electrical energy in a wired manner via the electrical contact between the contact device 9 and the contact points 8 in order to be able to supply electrical energy to an electrical load 12 mounted on the assembly unit, e.g. inserted into the latter, for example a light source. The assembly unit 10 e.g. in the form of an assembly profile has a light source, for example, linear lamps, as the load, for example.

In addition to the assembly unit 10, provision is made, on the plug-in object 1, for the electrical mounting device 13 having electrical contact points 14.

In the mounted state of the plug-in object 1, the contact points 14 are supplied with electrical energy via the electrical contact between the contact device 9 and the contact points 8, this being established by the line 26. An electrical information display 15 and e.g. a further information display 16 are inserted in the mounting device 13. In the inserted state of the information display 15, as well as of the information display 16, the information displays 15 and 16 are contacted so as to be supplied with electrical energy.

The electrical mounting device 13 is present structurally delimited from the assembly unit 10 by a partition 17.

The mounting device 13 is arranged on a front side 18 of the plug-in object 1, which front side, in the state in which the plug-in object 1 is mounted on the shelf system 2, is located at a front 19 of the shelf system 2 for a user.

In the assembly position, the mounting device 13 runs horizontally on the plug-in object 1 according to the horizontal line H (see FIG. 12).

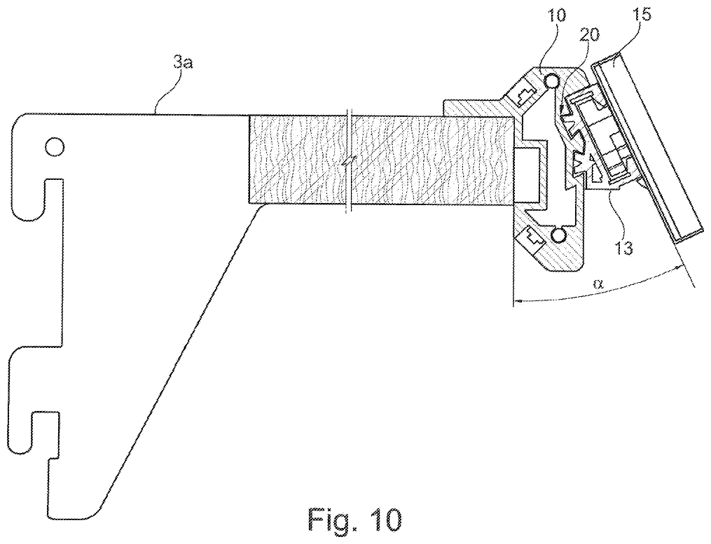

The electrical information display 15 or 16 is able to be latched into the mounting device 13 at any point along the mounting device 13 by way of e.g. latching means 20 (see FIG. 10) and is thus able to be electrically contacted.

At least two electrical contact points 14 for forming an electrical circuit when the information display 15, 16 is inserted are present on the mounting device 13.

The information display 15 and/or 16 are e.g. latched in the mounting device 13.

The plug-in object 1 comprises a voltage converter 21, for example, between the electrical contact at the plug-in part 3 and the mounting device 13 e.g. in the form of a current profile.

Electrical contact to the mounting device 13 e.g. in the form of a current profile is made via an electrical contact point 22 which is supplied with electricity via the line 26 (see FIG. 13).

Covering panels 23 are provided on both sides of the end-side ends of the assembly unit 10 and of the mounting device 13. Ends of the electrical lines 24, 25 and 26 converge at a covering panel 23. The ends of the electrical lines 24, 25 supply electrical energy to the contact points 11 for the loads 12. The end of the electrical line 26 supplies electrical energy to the contact point 22 on the mounting device 13 and thus to the information displays 15 and 16.

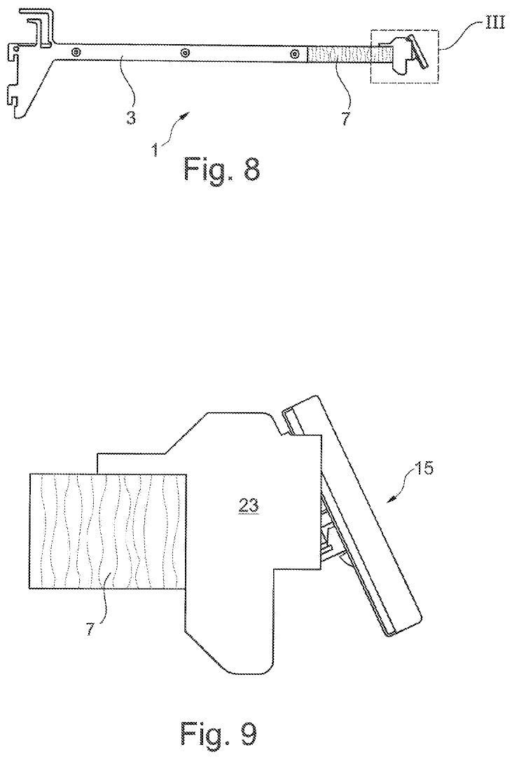

FIGS. 8-10 focus on an orientation of a display surface of the information display 15 which has a normal obliquely upward and is inclined by, for example, the angle α of e.g. 25 degrees with respect to the vertical (see FIG. 10).

### LIST OF REFERENCE SIGNS

1 Plug-in object
2 Shelf system
3, 3a Plug-in part
4, 4a Profile
5 Receptacle
6 Plug-in apparatus
7 Shelf
8 Contact point
9 Contact device
10 Assembly unit
11 Contact point
12 Load
13 Mounting device
14 Contact point
15 Information display
16 Information display
17 Partition
18 Front side
19 Front
20 Latching means
21 Voltage converter
22 Contact point
23 Covering panel
24 Line
25 Line
26 Line

1. A plug-in object of a shelf system for goods presentation having a plug-in part for a plug-in apparatus of the shelf system into which the plug-in part is able to be plugged in a matching receptacle, the plug-in part being configured in such a way that, in the state in which the plug-in object is plugged into the plug-in apparatus, the plug-in part forms electrical contact with a contact device in the plug-in apparatus, such as in a profile, and supplies electrical energy to an assembly unit having electrical contact points, in order to be able to supply electrical energy to an electrical load mounted on the assembly unit, e.g. inserted into the latter, for example a light source, wherein, in addition to the assembly unit, provision is made, on the plug-in object, for an electrical mounting device having electrical contact points, which electrical mounting device is supplied with electrical energy via the electrical contact and wherein an electrical information display is inserted in the mounting device, the information display being contacted so as to be supplied with electrical energy.

2. The plug-in object as claimed in claim 1, wherein the electrical mounting device is present structurally delimited from the assembly unit by a partition.

3. The plug-in object as claimed in either of the claim 1, wherein the mounting device is arranged on a front side of the plug-in object, which front side, in the state in which the plug-in object is mounted on a shelf system, is located at a front of the shelf system for a user.

4. The plug-in object as claimed in claim 1, wherein the mounting device runs horizontally on the plug-in object in the assembly position.

5. The plug-in object as claimed in claim 1, wherein an electrical information display is able to be latched into the mounting device at any point along the mounting device and is thus able to be electrically contacted.

6. The plug-in object as claimed in claim 1, wherein at least two electrical contact points for forming an electrical circuit when the information display is inserted are present on the mounting device.

7. The plug-in object as claimed in claim 1, wherein the information display is able to be latched into the mounting device.

8. The plug-in object as claimed in claim 1, wherein the plug-in object comprises a voltage converter between electrical contact at the plug-in part and current profile.

9. The plug-in object as claimed in-one of the preceding claim 1, wherein the mounting device is inserted into an assembly profile.

10. The plug-in object as claimed in claim 1, wherein the assembly profile has linear lamps.

11. The plug-in object as claimed in claim 1, wherein the assembly profile comprises electrical contact points for making contact with the current profile.

12. The plug-in object as claimed in claim 1, having electrical loads arranged thereon.

13. A shelf system composed of a plug-in object as claimed in claim 1 and a plug-in apparatus for the plug-in object.
